(19) United States
(12) Patent Application Publication
(10) Pub. No.: US 2024/0014539 A1
(43) Pub. Date: Jan. 11, 2024

(54) VEHICLE GLASS ANTENNA

(71) Applicant: AGC GLASS EUROPE, Louvain-la-Neuve (BE)

(72) Inventors: Kazuhiro NAKANO, Gosselies (BE); Manuel PAYEN, Gosselies (BE); Vincent VANDENBERGHE, Gosselies (BE)

(73) Assignee: AGC GLASS EUROPE, Louvain-la-Neuve (BE)

(21) Appl. No.: 18/251,438

(22) PCT Filed: Nov. 4, 2021
(86) PCT No.: PCT/EP2021/080673

§ 371 Date: May 2, 2023

(30) Foreign Application Priority Data
Nov. 5, 2020 (EP) 20206038.0

(51) Int. Cl. H01Q 1/12; H01Q 21/06

(52) U.S. Cl. CPC H01Q 1/1271; H01Q 21/061

(57) ABSTRACT

The present invention relates to a vehicle window pane intended to be placed into an opening in a vehicle's body, the opening having at least a first edge and a second edge and being continuously connected by a corner, provided with an antenna system comprising: —at least a first and a second antennas disposed on the vicinity of the corner; —the first and second antennas are designed to transmit/receive radio waves in the substantially same frequency range; —the first and second antennas have respectively a feeding portion placed close to each other; —the first antenna has: —a first part extending from its feeding portion in parallel to the first edge, the corner and the edge of the opening, said first part being a continuous line extended from the feeding portion along with the first edge, the corner and the second edge, and terminated at one crossing point along with the second edge, —a second part which is extended from the crossing point on said first part, the crossing point being located on a part of the first part which is substantially parallel to the second edge, the second part extending from the crossing point in substantially orthogonal direction from and opposite to the second edge of the opening; the second antenna has at least one part which is substantially orthogonal to the first edge of the opening, the part being electrically connected to the feeding portion; wherein α distance D between the feeding portion of the second antenna and the crossing point satisfies the following formula: (Formula), wherein a is shortening ratio of radio wavelength on window pane and λe is wavelength of radio wave at frequency fs in vacuum, fe is the highest frequency of the frequency band in which the first antenna and the second antenna works as a diversity-antenna system; and wherein a distance Du between the second part of the first antenna and the first edge satisfies the following formula: (Formula) wherein a is shortening ratio of radio wavelength on window pane and As is wavelength of radio wave at frequency fs, in vacuum, fs is the lowest frequency of the frequency band in which the first antenna and the second antenna works as a diversity-antenna system.

### TECHNICAL FIELD

The present invention relates to a vehicle glass provided with at least two antennas working in the same frequency band. The present invention also relates to a vehicle glass antenna system comprising at least two antennas working at the same frequency band.

### BACKGROUND ART

With the conventional glass antennas, multiple antennas for the same frequency band are placed on one window pane to form a diversity-antenna system. Each antenna is separately connected to Radiofrequencies (RF) cable and/or electronic devices (for example, amplifier module). Generally, two or more antennas need to be placed apart from each other to be well-isolated electrically. On the other hand, such diversity-antenna system makes the designing of a vehicle more complicated. Indeed, some additional cables and/or electronics need to be equipped separately for each antenna. Then, the material cost, the manufacturing cost and also the weight of a vehicle are increased.

Generally, to limit the impact of the vehicle design, several antennas are placed close to each other. However, if the feeding points of those antennas are placed closed to each other to integrate cables and electronics, the benefit of the diversity-antenna system would not be obtained due to the strong coupling between those antennas.

It is known from EP2009733 a glass antenna which is provided on a surface of a window glass of a vehicle for reception and transmission of radio waves by means of diversity-antenna system. The glass antenna described in EP2009733 has multiple antennas having feeding points apart from each other to realize good diversity-antenna system by reducing coupling between each antenna. However, having feeding points apart from each other lead to design issues for car manufacturer because it is then need to have two separate feeding structures (need more space and electronic devices).

Thus, there is a need to well-isolated antennas even when the feeding points of those antennas are placed close to each other.

### SUMMARY OF THE INVENTION

Therefore, the present invention proposes a vehicle antenna system to be provided on a vehicle glass comprising multiple antennas to form good diversity-antenna system even when the feeding points of those antennas are placed close to each other.

Then, an object of the invention is to provide a vehicle glass antenna system and a vehicle window glass for a vehicle glass antenna as disclosed in claim 1 which has at least two antennas for the same frequency band, with their feeding points placed close to each other, and both of them has good gains. For example, those antennas may be for receiving radio waves for Television (TV) broadcast services.

The antennas provided onto one window pane according to the present invention are designed to have good gain (G) at the same frequency (f), and less correlation factor (ρ) between each antenna. The antennas according to the present invention contribute to enhance the transmitting/receiving performances of the radio signals. According to the present invention, the gain (G) of each antenna is calculated according the formula as follows:

$${G}_{1} ( f ) = 20 \cdot {log}_{10} ( \frac{1}{{N}_{φ}} {\sum }_{φ} \vert {E}_{1} ( f , φ ) \vert )$$

$${G}_{2} ( f ) = 20 \cdot {log}_{10} ( \frac{1}{{N}_{φ}} {\sum }_{φ} \vert {E}_{2} ( f , φ ) \vert )$$

$${G}_{total} ( f ) = 20 \cdot {log}_{10} ( \frac{1}{{N}_{φ}} {\sum }_{φ} ( \vert {E}_{1} ( f , φ ) \vert + \vert {E}_{2} ( f , φ ) \vert ) )$$

Here, f is the frequency of the radio wave to be received/transmitted by the antenna, φ is the azimuth angle around the vehicle onto which the antenna is placed. E(f,φ) is the signal strength received/transmitted by the antenna toward the direction (pin substantially horizontal plane around the vehicle. E(f, φ) is a complex value containing an amplitude and phase information of the signal. N_{φ} is the number of the measured azimuth angles. Thus, G₁(f) and G₂(f) represent the gain of the first antenna and the second antenna at frequency f, which are averaged for azimuth angles all around the vehicle. Gₜₒₜₐₗ represents the sum of the signal strengths of the first antenna A1 and the second antenna A2. Here, G₁, G₂ and Gₜₒₜₐₗ are calculated as dB scale.

Also, according to the present invention, the envelope correlation coefficient (ECC) between the at last two antennas is calculated according the formula as follows:

$$ρ ( f ) = \frac{{\sum }_{φ} {E}_{1} ( f , φ ) \cdot {E}_{2}^{*} ( f , φ )}{\sqrt{{\sum }_{φ} {\vert {E}_{1} ( f , φ ) \vert}^{2}} \sqrt{{\sum }_{φ} {\vert {E}_{2} ( f , φ ) \vert}^{2}}}$$

The envelope correlation coefficient (ECC) is well-known to those skilled in the art as explained in the following web site: http://www.antenna-theory.com/definitionsienvelope-correlation-coefficient-ecc.php.

Generally, to improve the transmitting/receiving performance of such diversity-antenna system, all the antennas should have good gains, and also they should have less correlation factor. Thus, the present invention proposes a vehicle glass antenna system which has higher Gₜₒₜₐₗ and lower ρ.

In the present invention, the inventors have shown that it is possible to obtain good gains and less correlation factor between the at least glass antenna system according to the present invention even if the feeding points of those antennas are placed close to each other.

The present invention proposes a good diversity glass antenna system with low cost and easiness of vehicle designing that can be provided onto a window pane to be placed on a vehicle.

In order to achieve the above object, the present invention provides a vehicle window pane to be placed into an opening in a vehicle's body, the opening having at least a first edge E1 and a second edge E2, E1 and E2 being continuously connected by a corner C1, provided with an antenna system 100 comprising:
at least a first and a second antennas (A1, A2) disposed on the vicinity of the corner C1
the first and second antennas are designed to transmit/receive radio waves in the substantially same frequency range
the first and second antennas have respectively a feeding portion FP1, FP2 placed close to each other,
the first antenna A1 has:
   a first part L11 extending from its feeding portion FP1 in parallel to the edge E1, the corner C1 and the edge E2 of the opening O. Thus; L11 being a continuous line extended from FP1 along with E1, C1 and E2, and terminated at one crossing point BP along with E2,
   a second part L12 which is extended from one point (BP) on L11, the crossing point (BP) being located on the part of L11 which is substantially parallel to E2. The second part L12 extends from the crossing point (BP) in substantially orthogonal direction from and opposite to the edge E2 of the opening O,
   the second antenna A2 has at least a part L2 which is substantially orthogonal to the edge E1 of the opening O, L2 being electrically connected to the feeding portion FP2.

According to the present invention, a distance D between the feeding portion FP2 of the second antenna A2 and the crossing point BP satisfies the following formula: D≥αλₑ/2, wherein α is shortening ratio of radio wavelength on window pane and is wavelength of radio wave in vacuum at frequency fₑ fₑ is the highest frequency of the frequency band in which the first antenna A1 and the second antenna A2 works as a diversity-antenna system. According to the present invention, a distance D₁₁ between the second part (L12) of the first antenna (A1) and the first edge (E1) satisfies the following formula:

$$α \frac{{λ}_{s}}{8} < {D}_{11} < {αλ}_{s}$$

wherein α is shortening ratio of radio wavelength on window pane and λₛ is wavelength of radio wave at frequency fₛ in vacuum, fₛ is the lowest frequency of the frequency band in which the first antenna (A1) and the second antenna (A2) works as a diversity-antenna system.

In a preferred embodiment, the at least first antenna A1 and second antenna A2 are provided on a backlite window glass of a vehicle.

For example, the first and second antennas are designed to work in a frequency band between 470 MHz and 710 MHz. In this case, D≥αλₑ/2=148 mm when α=0.7. By this feature, the first antenna A1 and the second antenna A2 can have high gains keeping low envelop correlation coefficient.

According to the present invention, the first edge E1 may be an horizontal edge (the upper or bottom edge) or a vertical (lateral) edge of the opening O of the vehicle's body, and the second edge E2 may be the upper or bottom edge or a lateral edge provided that the edges E1 and E2 are substantially orthogonal.

Note that “horizontal” in the present invention is used to mean a direction generally parallel to the installation surface of the vehicle, and “vertical” refers to a direction generally orthogonal to “horizontal”. Accordingly, “horizontal” and “vertical” do not necessarily indicate strict directions, and, for example, what is referred to as “horizontal” may be slightly inclined rather than being strictly parallel to the installation surface of the vehicle. The meanings of “horizontal” and “vertical” are the same throughout this specification.

According to the present invention, the feeding portion constitutes a part which electrically connects the antenna conductor to cables and/or electronics in a vehicle whereby the window pane is installed in an opening in the vehicle intended to receive the window pane.

According to the present invention, the feeding portions of the at least the first and the second antennas are disposed so as to be aligned along a reference direction, along at least one of an edge of the window pane. Furthermore, the first and the second antenna are placed close to each other.

Further, in order to achieve the above object, the present invention provides a vehicle window glass on which the glass antenna according to the present invention is provided.

### Advantages of the Invention

According to the present invention, it is possible to obtain a performed good diversity antenna system provided on a vehicle glass panel suitable for receiving radio waves for Television (TV) broadcast services with low cost and easiness of vehicle designing.

In a preferred embodiment, the at least first antennas A1 and second antenna A2 are provided on typical backlite window glass, and it was equipped on a sedan shaped car. Preferably, those antennas were made for frequency band from 470 MHz to 710 MHz. In this case, D≥αλₑ/2=148 mm when α=0.7.

According to one embodiment of the present, a distance d between Feeding portion FP1 and Feeding portion FP2 satisfies the following formula: d≤50 mm. Thus, the feeding cables and/or the electronics to be connected to A1 and A2 are easier to be integrated physically.

According to one embodiment of the present, a distance d₁ between Feeding portion FP1 and the closest opening body's edge E1 satisfies the following formula d₁≤αλₛ/8. Here, is still the wavelength of radio wave in vacuum at frequency fₛ, fₛ is the lowest frequency of the frequency band in which the first antenna A1 and the second antenna A2 works as a diversity-antenna system. Thus, the input impedance of the first antenna A1 can be easier to be adjusted, and the efficient feeding can be realized. Furthermore, the feeding point FP1 can be less visible from the passengers because it is close to the edge of the opening O.

According to one embodiment of the present, the distance d₂ between FP2 and the closest vehicle body's edge E1 satisfies the following formula d₂≤αλₛ/8 Thus, the input impedance of the first antenna A2 can be easier to be adjusted, and the efficient feeding can be realized. Furthermore, the feeding point FP2 can be less visible from the passengers because it is close to the edge of the opening O.

According to one embodiment of the present, the distance g between the first part L11 of the first antenna A1 and the edge E1, C1 and E2 of the opening O satisfies g≤αλₛ/8. Thus, the contribution of the first part L11 to the radio wave radiation can be reduced by the image currents induced on the opening O. The coupling between the first antenna A1 can be also reduced, and the envelop correlation coefficient between the first antenna A1 and the second antenna A2 becomes lower.

According to an embodiment of the present invention, the length L1 of the shortest path from FP1 to the terminating end point of L12 along with the antenna A1, satisfies the following formula: (2n₁−1)αλₑ/4≤L₁≤(2n₁−1)αλₛ/4, here, n₁≥2, natural number.

Thus, the first antenna A1 resonates in the higher-order mode at the designated frequency range, and the good gain of the first antenna A1 can be obtained.

According to an embodiment of the present invention, the length of the second part (L₁₂) of the antenna A1 satisfies the following formula: (2n₁₂−1)αλₑ/4≤L₁₂≤(2n₁₂−1)αλₛ/4, *here, n₁₂≥1, natural number. Thus, the crossing point BP on the first antenna A1 becomes the antinode of the current distribution in the designated frequency range, and the gain of A1 can be even enhanced.

According to an embodiment of the present invention, the length of the part L2 of the second Antenna A2 satisfies the following formula: (2n₂−1)αλₑ/4≤L₂≤(2n₂−1)αλₛ/4, where, n₂≥1, natural number. Thus, the second antenna A2 resonates in the first or higher-order mode at the designated frequency range, and the good gain of A2 can be obtained.

According to an embodiment of the present invention, the feeding portions FP1 and FP2 are each electrically connected to amplifier 31 circuits. In a preferred embodiment, the amplifier 31 circuits are provided in a same housing and having a common ground electrically connected to the vehicle body. Thus, the installation and deployment of such amplifiers becomes simpler, and the manufacturing cost and the designing of vehicle can be improved.

According to one embodiment of the present invention, the backlite (also called rear window) is a provided with defoggers. Defoggers may be formed by the same material as antenna conductors as for example silver print wires.

Here, the “terminating end portion” may be a terminal point of the extension of a part of an antenna in front of and in the vicinity of the terminal point.

The feeding portions FP1 and FP2 and the antenna part connected to the feeding portions are formed by printing and baking a paste containing a conductive metal such as a silver paste on an inner surface of a pane of window glass. However, the invention is not limited to this forming method. A linear element or a foil element made of a conductive material such as copper may be formed on an inner or outer surface of a window glass or may be affixed to a window glass with an adhesive or may be provided in an inside of a window glass itself. Additionally, a glass antenna may be formed by forming a conductor layer given synthetic resin film in which a conductor layer of an antenna conductor is provided in the inside or on a surface, of a synthetic resin film on an inner surface of an outer surface of a pane of window glass. Further, a glass antenna may be formed by forming a flexible circuit board on which an antenna conductor is formed on an inner surface or an outer surface of a pane of window glass.

According to one embodiment of the present invention, the parts of the antennas A1 and A2 are preferably made of the same material. In a preferred embodiment, the antennas A1 and A2 are made of a metallic plate electrically connected to the ground portion which is electrically connected to the vehicle body.

On the other hand, the periphery of the window pane may be provided with an enamel to hide the unaesthetic part of the window pane. Preferably, FP1, FP2 and L11 are placed on the enamel portion and invisible from outside of the vehicle.

In addition, when two coaxial cables are used for feeding the antenna A1 and A2 via the feeding portions FP1 and FP2, the inner conductors of two coaxial cables may electrically be connected to the feeding portion FP1 and FP2 separately, while the outer conductors of the coaxial cables may be electrically connected to the vehicle's body.

In addition, when electronic device (typically, amplifier or tuner) is connected to the antennas, simple conductive wires can be connected from feeding portions FP1 and FP2 to the inputs of those electronics separately, and the electronics may be in the same housing, and both electronics may have a common ground, and the common ground may be connected to the car body. Thus, the length of cables can be short and the installation of the electronics can be simpler, and it enables the vehicle designing to be simple, and the low material cost and lighter weight of the vehicle can be realized.

A mounting angle of the window glass relative to the vehicle is preferably in the range of 15 to 90° and is more preferably in the range of 30 to 90°. The design of the antennas should be adapted to the design of the car and the installation of the window within the opening.

### BRIEF DESCRIPTION OF THE DRAWINGS

FIG. 1 is a front view of a rear window of a vehicle in which an embodiment of a vehicle window glass according to the present invention is mounted.

FIGS. 2a and 2b are plan views of a window glass according to working examples of a vehicle glass antenna of the present invention.

FIG. 3 is zoom of the encircled part of the FIG. 2a.

FIGS. 4a and 4b are plan views of a window glass according to comparative examples 1 and 2.

FIG. 4c a plan view of a window glass according to one embodiment of the present invention.

FIG. 5a is a measured data of envelop correlation coefficient for horizontal polarized radio wave between two antennas in comparative and working examples

FIG. 5b and FIG. 5c are measured data of the antenna gains of comparative and working examples.

FIGS. 6a and 6b are plan views of a window glass according to embodiments of the present invention.

### EMBODIMENT FOR CARRYING OUT THE INVENTION

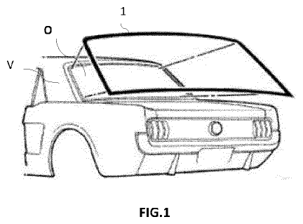

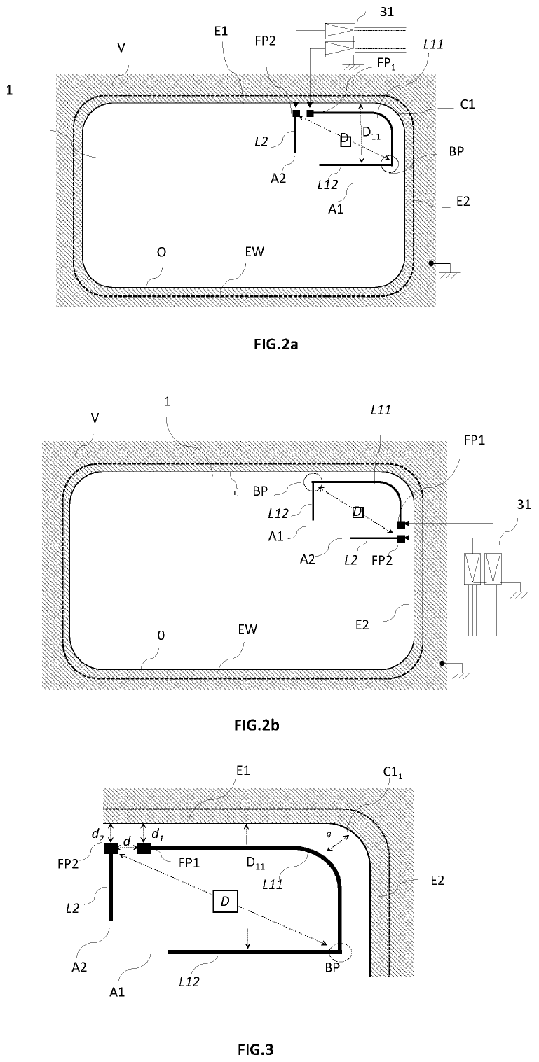

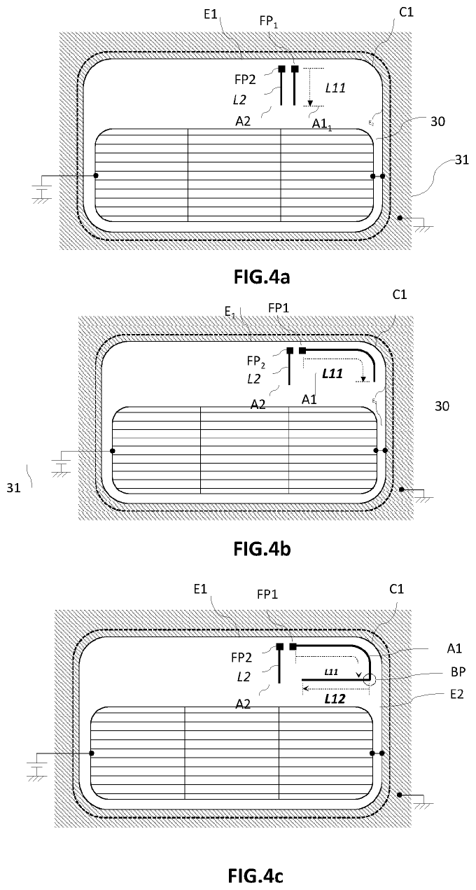

Hereinafter, referring to the drawings, an embodiment for carrying out the invention will be described. In the drawings which depict the embodiment, when directions are mentioned without mentioning any specific direction in which the drawings are seen, directions on the drawings are to be referred to. For the sake of clarity, the same reference number are used for the same part in the FIG. 1 to FIG. 4c. In addition, the drawings may be referred to as those showing views of the antennas when they are seen from the inside of the passenger compartment of the vehicle. It is understood that respective dimensions of portions of the glass antennas take values (in mm) shown in FIGS. 2 and 3. For example, in the case of a window glass 1 being a backlite which is mounted at a back portion of the vehicle, a left-to-right direction on each of the drawings corresponds to a vehicle width direction. In addition, although a feeding portions are disposed so as to be aligned along a reference direction in the invention, the reference direction can be set freely depending on a region where to place a glass antenna. In particular, in the case of a window glass of a vehicle, the reference direction is preferably set in a direction parallel to an edge portion of the opening in the vehicle body wherein the window glass is intended to be placed, a horizontal direction or a vertical direction. In an embodiment which will be described below, a horizontal plane when a vehicle window glass is installed in a vehicle constitutes a reference direction. The invention is not limited to the application to a backlite but may be applied to a windscreen, a backlite (rear) window glass which is mounted at a rear portion of the vehicle or a side window glass which is mounted in a side portion of the vehicle.

FIG. 1 is a front view of a back portion of a vehicle wherein a backlite 1 is intended to be placed into an opening O provided in the vehicle body. The size of the opening O is slightly smaller than the size of the window glass 1 and is designed to fit with the shape of the window glass 1. The opening has at least a first edge E1 and a second edge E2. The edges E1 and E2 are continuously connected by a corner C1 and comprising a glass antenna system 100. The corner C1 is generally a rounded, curved corner with an arch-like shape. Generally, the backlite is glued to the opening O and a gasket is provided between the edges of the opening O and the backlite to ensure the sealing between the two parts.

FIG. 2a is a front view of a rear window 1 (backlite) of a vehicle to which the vehicle window pane 1 according to the present embodiment is provided. The vehicle window pane 1 in the present embodiment is a tempered window pane 1 comprising a glass antenna system 100 according to the invention. The vehicle glass antenna 100 comprises at least a first and a second antennas, feeding portions for each antenna FP1, FP2, provided on a vehicle window glass 1 in a planar way. The feeding portions FP1, FP2 are placed close to each other and along with the edge E1 of the opening O in a predetermined reference direction (for example, a horizontal or substantially horizontal direction).

The vehicle glass antenna 100 includes, as an antenna conductor pattern, an antenna element as a first antenna A1, an antenna element as a second antenna A2 with each feeding point to connect antenna element to cable and/or electronics in the vehicle. According to the present invention, the first and the second antenna A1, A2 are provided onto the surface of the window pane 1 more particularly in vicinity of the corner C1 of the opening O of the vehicle body V wherein the window pane 1 is intended to be placed. The first and the second antennas A1, A2 are placed on the same edge of the window pane.

According to the present invention, the first antenna A1, provided onto the window pane, has a first part L11 which continuously extends from the feeding portion FP1 in parallel to the upper edge E1, the corner C1 and the right edge E2 of the opening O of the vehicle body wherein the window pane 1 will be placed. According to the present invention, the first part L11 of the first antenna A1 is provided with a crossing point BP from which the second part L12 extends. Here, the crossing point BP is on the portion of L11 in parallel to the right edge E2 of the opening O.

According to the present invention, a second part L12 of the first antenna A1 extends from the crossing point BP on L11 of the first antenna A1. The second part L12 of the first antenna A1 extends from the crossing point BP being the end of the first part of the antenna A1 as a starting point in a second direction (a leftward direction in the drawings) which is an opposite direction to the first direction.

According to the present invention, the second part L12 of the first antenna A1 extends in a second direction which is substantially orthogonal to the second edge E2 of the opening O in the body vehicle; here the second edge E2 is the lateral edge of the opening in the body vehicle. The second part L12 is directed inwards of an outer circumference of the window glass.

According to the present invention, it is understood that the size of the first and the second part of the first antenna A1 is determined by the design of vehicle and the frequency band in which the antennas are expected to work. Here, the first antenna A1, the second antenna A2 are provided with the same material as silver print wires. Generally, the typical width of those silver print wires is between 0.4 mm and 1.0 mm, but it can be adapted even thicker than 1.0 mm to optimize the performances of the antennas.

According to the present invention, the second antenna A2 is disposed close to the first antenna A1. The feeding portions FP1 and FP2 of the first and the second antennas A1, A2 are placed to be aligned along a reference direction on the vicinity of the corner C1 and along the same edge of the window pane. Here in the drawing, the first and the second antennas A1, A2 are positioned on the same upper edge of the window glass parallel to the closest upper edge E1 of the opening of the vehicle body. The second antenna A2, extends from its feeding portion FP2 and is substantially orthogonal to the upper edge E1 of the opening O of the vehicle body. The second antenna A2 is directed inwards of an outer circumference of the window glass.

FIG. 2b is another example of a vehicle to which the vehicle window pane 1 according to the present embodiment is provided. The feeding portions FP1 and FP2 of the first and the second antennas A1, A2 are placed to be aligned along a reference direction on the vicinity of the corner C1 and along the same edge of the window pane EW represented in FIGS. as dot line. Here in the drawing, the first and the second antennas A1, A2 are positioned on the same right edge of the window glass parallel to the closest right edge E1 of the opening of the vehicle body. The second antenna A2, extends from its feeding portion FP2 and is substantially orthogonal to the right edge E1 of the opening O of the vehicle body. The second antenna A2 is directed inwards of an outer circumference of the window glass.

FIG. 3, which is a zoom of the encircled part of the FIG. 2a. shows an antenna system 100, according to the present invention. The feeding portion FP2 of the second antenna A2 and the crossing point BP on the first antenna A1 are separated by a the distance D that satisfies the following formula: D≥αλₑ/2, wherein α is shortening ratio of wavelength on window pane and being the wavelength of radio wave at frequency fₑ. fₑ is the highest frequency of the radio wave to be received and/or transmitted by the antennas according to the present invention. A distance D₁₁ between the second part (L12) of the first antenna (A1) and the first edge (E1) satisfies the following formula:

$$α \frac{{λ}_{s}}{8} < {D}_{11} < α {λ}_{s}$$

wherein α is shortening ratio of radio wavelength on window pane and λₛ is wavelength of radio wave at frequency fₛ in vacuum, fₛ is the lowest frequency of the frequency band in which the first antenna (A1) and the second antenna (A2) works as a diversity-antenna system. In FIG. 3 according to an example of the present invention, the antennas A1 and A2 were designed in such dimensions as follows. The distance D between the feeding portion FP2 of the second antenna A2 and the crossing point BP on the first antenna A1 are separated by a the distance D equal to 270 mm. The distance Du between the second part (L12) of the first antenna (A1) and the first edge (E1) is equal to 120 nm. According to the present example, the center of the feeding portion FP1 of the first antenna A1 and the feeding portion FP2 of the second antenna A2 are separated by a distance d equal to 20 mm According to the present example, the distance d1 and d2 between respectively the center of the feeding portion FP1 of the first antenna A1 and the center of the feeding portion FP2 of the second antenna A2 and the edge E1 of the opening O of the vehicle's body are equal to 20 mm (d1=d2). The distance g between the first part L11 of the first antenna A1 is equal to d1 and d2 and equal to 20 mm According to one embodiment of the present invention, the total length L1 of the first antenna A1 is comprised between 345 mm and 545 mm with L12 comprised between 35 mm and 235 mm. According to one embodiment of the present invention, the length L2 of the second antenna A2 is equal to 80 mm.

### Example According One Embodiment of the Present Inventive and Comparative Examples

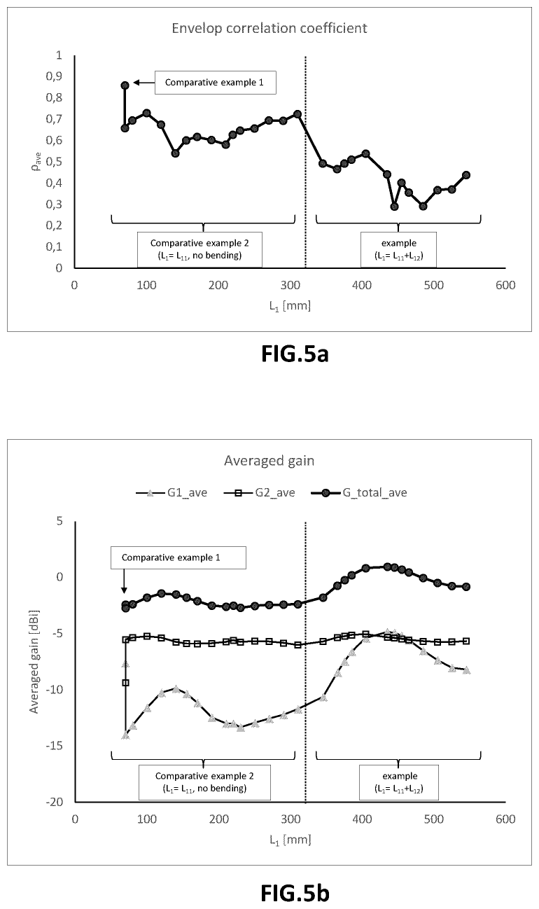

The comparative examples are shown in FIGS. 4a and 4b, and an example according to the present invention is shown in FIG. 4c. Here, α=0.7, fₛ=470 MHz, fₑ=710 MHz. Here in the drawings, a defogger 30 is also placed on the window pane. The first antenna A1 and the second antenna A2 are placed not in contact with the defogger 30. Here, the first antenna A1, the second antenna A2 and defogger 30 are provided with the same material as silver print wires. The width of those silver print wires are 0.4 mm.

In FIGS. 4a, 4b and 4c, the center of the feeding portion FP1 of the first antenna A1 and the feeding portion FP2 of the second antenna A2 are separated by a distance d equal to 20 mm. The distance d1 and d2 between respectively the center of the feeding portion FP1 of the first antenna A1 and the center of the feeding portion FP2 of the second antenna A2 and the edge E1 of the opening O of the vehicle's body are equal to 20 mm (d1=d2).

In FIG. 4a, a first antenna A1 is provided on the edge of the glass pane parallel to the edge E1 of the opening O, in the vicinity of the corner C1 of the vehicle's body. The first antenna A1 has a part L1 of which extends from the center of the feeding portion FP1 to the extremity of the antenna A1. Here, L1 satisfies the formula αλₑ/4≤L₁≤αλₛ/4 and it is extended from feeding point FP1 in orthogonal direction to the closest edge E1. The first antenna A1 is then a quarter-wavelength monopole antenna.

The second antenna A2 and more particularly its feeding portion FP2 is placed closed to the feeding portion FP1 of the first antenna A1. The second antenna A2 is provided on the same edge of the glass pane than the antenna A1 on the left side of the antenna A1.

The second antenna A2 has a part L2 which extends from its feeding portion FP2 and is substantially orthogonal to the edge E1 of the opening O of the vehicle's body and the length L2 is 80 mm. Then, A2 also consists a quarter-wavelength monopole antenna.

In FIG. 4b, a second comparative example is shown. Thus, the first antenna A1, is provided onto the window pane. The first antenna A1 has a first part L11 which continuously extends from the feeding portion FP1 in parallel to the upper edge E1, the corner C1 and the right edge E2 of the opening O of the vehicle body wherein the window pane 1 will be placed. The first antenna A1 has a total length L₁ from 80 mm to 310 mm from the center of the feeding portion FP1 to the extremity of the antenna A1. For example, when L1 has a length comprised between 80 mm and 110 mm, L1 satisfies the formula αλₑ/4≤L₁≤αλₛ/4 to resonate in the frequency band. In the case of the length of L1 is comprised between 222 mm and 310 mm, L1 satisfies the formula 3αλₑ/4≤L₁≤3αλₛ/4 to resonate in the frequency band.

The second antenna A2 and more particularly its feeding portion FP2 is placed closed to the feeding portion FP1 of the first antenna A1. The second antenna A2 is provided on the same edge of the window pane than the antenna A1 on the left side of the antenna A1. The second antenna A2 has a part L2 which extends from its feeding portion FP2 and is substantially orthogonal to the edge E1 of the opening O of the vehicle's body. The second antenna A2 has a length of 80 mm. Here, L2 also satisfies the formula αλₑ/4≤L₂≤αλₛ/4 and the second antenna A2 is then a quarter-wavelength monopole antenna. In the comparative example 2, the design of the antenna A2 is the same than the design according to the present invention. The antenna A1 in comparison with the present invention, is devoid of the second part L12.

In FIG. 4c, an antenna system 100 provided onto the window pane according to the present invention comprises a first antenna A1 and a second antenna A2. The first antenna A1 has a first part L11 which continuously extends from the feeding portion FP1 in parallel to the upper edge E1, the corner C1 and the right edge E2 of the opening O of the vehicle body wherein the window pane 1 will be placed. Also, the first antenna A1 has a second part L12 which extends from the crossing point BP on L11. The crossing point BP is located on the part of L11 which is substantially parallel to E2. Here, the first part L11 has a length of 310 mm, and the second part L12 has a length comprised between 35 mm and 235 mm. Thus, the total length L1 satisfies the formula 5αλₑ/4≤L₁≤5αλₛ/4 when L12 has a length comprised between 60 mm and 235 mm. Also, the length L12 satisfies the formula αλₑ/4≤L₂≤αλₛ/4 when L12 has a length comprised between 74 mm and 112 mm.

The second antenna A2 and more particularly its feeding portion FP2 is placed closed to the feeding portion FP1 of the first antenna A1. The second antenna A2 is provided on the same edge of the window pane than the antenna A1 on the left side of the antenna A1. Here, the distance D between FP2 and BP is 270 mm, and it satisfies D≥αλₑ/2. The second antenna A2 has a part L2 which extends from its feeding portion FP2 and is substantially orthogonal to the edge E1 of the opening O of the vehicle's body. The part L2 has a length of 80 mm. Here, L2 also satisfies the formula αλₑ/4≤L₂≤αλₛ/4 and the second antenna A2 is then a quarter-wavelength monopole antenna.

To evaluate the diversity performances based on the antenna gain measurements, two indicators have been defined by inventors. Thus, the first indicator measured has been the envelop correlation coefficient (φ. The correlation factor takes the amplitude and phase difference between the first antenna A1 and the second antenna A2 into account. More the factor p is lower more the first antenna A1 and the second antenna A2 are well isolated and better is the diversity performance. The second factor measured has been the averaged gain. More the average is higher more the antenna system 100 comprising a first and a second antennas A1 and A2 is better.

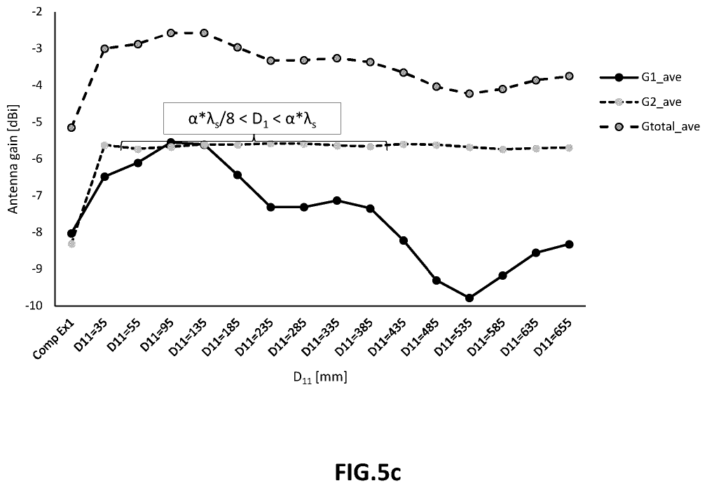

The antenna gains and the envelop correlation coefficient for the example according to the present invention and for the first and second comparative examples are shown in FIGS. 5a, 5b and 5c. As shown in these figures, the glass antenna 100 according to the present invention shows a good efficiency for reception of radio waves of a high-frequency band and is particularly suitable for reception of the TV broadcasting frequency band (470 to 710 MHz).

Then, far-field antenna gains for horizontal polarized radio wave were measured on those antennas in every 1° of azimuth angles (φ) around the vehicle, for each frequency (f). The floor condition of the test site was considered as free space. The elevation angle between the transmitting antenna and the floor was approx. 8 degrees.

The signal strength received by those antennas were measured by 50-ohm measurement system as the complexed values (E(f, φ)), and antenna gains were calculated in dBi scale. Car body metal is connected to the ground of measurement system.

Then, the gains and the envelope correlation coefficient are averaged over all measured frequencies based on the formula as follows:

$${G}_{a v e 1} = \frac{1}{{N}_{f}} {\sum }_{f} {G}_{1} ( f )$$

$${G}_{a v e 2} = \frac{1}{{N}_{f}} {\sum }_{f} {G}_{2} ( f )$$

$${G}_{ave total} = \frac{1}{{N}_{f}} {\sum }_{f} {G}_{total} ( f )$$

$${ρ}_{a v e} = \frac{{N}_{f}}{{\sum }_{f} \frac{1}{ρ ( f )}}$$

Here, N_{f} is the number of the measured frequencies in the designated frequency band.

As shown in FIGS. 5a, 5b and 5c, the antenna system 100 according to the present invention realizes both lower correlation (φ and higher gain (Gₜₒₜₐₗ) compared to the comparative examples, meaning they are much better ‘diversity antenna system’ than comparative examples.

By making the bending shape on the first antenna A1 according to the present invention (ground-parallel L₁₁ and ground-orthogonal L₁₂), the gain of the first antenna A1 has been improved, keeping gain of the second antenna A2 almost constant.

By extending the first part L11 of the first antenna A1 apart from the feeding portion FP2 of the second antenna A2 (more than αλₑ/2), the effective distance between the first antenna A1 and the second antenna A2 became large enough to be well-isolated in the interested frequency range (lower φ, even though Feeding portion FP1 of the first antenna A1 and the Feeding portion FP2 of the second antenna A2 are very close to each other.

The invention is used for automobile glass antennas for receiving the terrestrial digital TV broadcasting and analog TV broadcasting in preferably a frequency comprised between 470 MHz and 710 MHz.

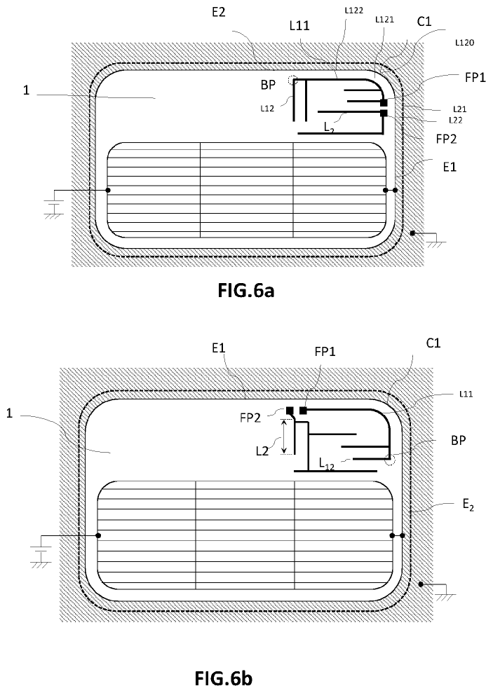

FIG. 6a shows another example of a window pane according to the present invention which comprises a first antenna A1 and a second antenna A2. Here, the first antenna A1 has the feeding portion FP1 along with the right edge E1, the first part L11 which continuously extends from the feeding portion FP1 in parallel to the right edge E1, the corner C1 and the upper edge E2. Also, the first antenna A1 has a second part L12 which extends from the crossing point BP on L11. The crossing point BP is located on the part of L11 which is substantially parallel to the upper edge E2. The second antenna A2 is provided on the same edge of the window pane than the antenna A1 on the lower side of the antenna A1. The second antenna A2 has a part L2 which extends from its feeding portion FP2 and is substantially orthogonal to the edge E1.

According to the present embodiment, the first antenna A1 has further to extended second part L12, a third part L120 extended to the feeding portion FP1 and being substantially orthogonal to the edge E1, a fourth part L121 extended from the first part L11 and being substantially orthogonal to the edge E1 too, and a fifth part L122 extended from the first part L11 and being substantially orthogonal to the edge E2 and parallel to the second part L12 of the first antenna A1.

According to the present embodiment, the second antenna A2 has further to the extended part L2, a second part L21 extending from the feeding portion FP2 of the second antenna A2 and being parallel to the first edge E1 of the opening, and a second part L22 extending from the end of the second part L21 and being parallel to the first part L2.

According to the present invention, the number, the size and the shape of the different part further to first and second parts (L11, L12) of the antenna A1 and the first part (L2) of the antenna A2 are fixed according to frequencies targeted.

Those antennas are designed on a vehicle window glass to work as the diversity-antenna system in TV band, so here, α=0.7, fₛ=470 MHz, fₑ=710 MHz. The dimensions of each part are; D=350 mm, L11=355 mm, L12=110 mm, L2=270 mm, and d=20 mm, d1=d2=15 mm, g=40 mm Here, it satisfies D≥αλₑ/2, d1≤αλₛ/8, d2≤αλₛ/8, g≤αλₛ/8, 5αλₑ/4≤L1=L11+L12≤5αλₛ/4, αλₑ/4≤L12≤αλₛ, 3αλₑ/4≤L2≤3αλₛ/4. It is understood in the case of multiple parts of the first antenna A1, D is calculated from the farthest crossing point BP of the first antenna A1 and the feeding point FP2 of the antenna A2. Thus, those antennas have good gains and low correlation coefficient in TV band. Also, since two feeding portions are placed close to each other (d≤50 mm), it is easy to integrate cables and amplifiers physically into the same housing, and it makes the vehicle design simpler and lower-costed. Some other wires on A1 and A2 are placed to enhance the antenna gains in the different frequency band from TV band, so they are not related to the effect of this invention directly.

FIG. 6b shows another practical working example of a window pane according to the present invention which comprises a first antenna A1 and a second antenna A2. Here, the first antenna A1 has the feeding portion FP1 along with the upper edge E1, the first part L11 which continuously extends from the feeding portion FP1 in parallel to the upper edge E1, the corner C1 and the right edge E2. Also, the first antenna A1 has a second part L12 which extends from the crossing point BP on L11. The crossing point (BP) is located on the part of L11 which is substantially parallel to the right edge E2. The second antenna A2 is provided on the same edge of the window pane than the antenna A1 on the left side of the antenna A1. The second antenna A2 has a part L2 which extends from its feeding portion FP2 and is substantially orthogonal to the edge E1.

As for FIG. 6a, the first antenna A1 and the second antenna A2 have a kind of ramifications as parts of antennas A1 and A2. The number, the size and the shape of the different part further to first and second parts (L11, L12) of the antenna A1 and the first part (L2) of the antenna A2 are fixed according to frequencies targeted.

Those antennas are designed on a vehicle window glass to work as the diversity-antenna system in TV band, so here, α=0.7, fₛ=470 MHz, fₑ=710 MHz. The dimensions of each part are; D=270 mm, L11=260 mm, L12=90 mm, L2=110 mm, and d=20 mm, d1=d2=15 m, g=40 mm Here, it satisfies D≥αλₑ/2, d1≤αλₛ/8, d2≤αλₛ/8, g≤αλₛ/8, αλₑ/4≤L12≤αλₛ, αλₑ/4≤L2≤αλₛ/4. Thus, those antennas have good gains and low correlation coefficient in TV band. Also, since two feeding portions are placed close to each other (d≤50 mm), it is easy to integrate cables and amplifiers physically into the same housing, and it makes the vehicle design simpler and lower-costed. Some other wires on A1 and A2 are placed to enhance the antenna gains in the different frequency band from TV band, so they are not related to the effect of this invention directly.

### INDUSTRIAL APPLICABILITY

The invention is used for automobile glass antennas for receiving the terrestrial digital TV broadcasting and analog TV broadcasting in Europe, United States, Japan, Republic of China. The invention is used for automobile glass antennas for receiving the terrestrial digital TV broadcasting (698 to 806 MHz) in the United States, the digital TV broadcasting (470 to 862 MHz) in the regions within the European Union or the digital TV broadcasting in People's Republic of China. In addition, the invention can also be used for the FM broadcasting band (76 to 90 MHz) in Japan, the FM broadcasting band (88 to 108 MHz) in the United States, the TV VHF bands (90 to 108 MHz, 170 to 222 MHz), the 800 MHz band (810 to 960 MHz) for automobile mobile phones, the 1.5 GHz band (1.429 to 1.501 GHz) for automobile mobile phones, the UHF band (300 MHz to 3 GHz), GPS (Global Positioning System), the GPS signal (1575.42 MHz) from artificial satellites, and VICS (trade name) (Vehicle Information and Communication System: 2.5 GHz).

Further, the invention can also be used for communication for ETC (Electronic Toll Collection System: Non-stop automatic toll correction system, transmission frequency for roadside radio communication system: 5.795 GHz or 5.805 GHz, reception frequency for roadside radio communication system: 5.835 GHz or 5.845 GHz), DSRC (Dedicated Short Range Communication, 915 MHz band, 5.8 GHz band, 60 GHz band), microwaves (1 GHz to 3 THz), millimeter waves (30 to 300 GHz), keyless entry system for vehicle (300 to 450 MHz), and SDARS (Satellite Digital Audio Radio Service (2.34 GHz, 2.6 GHz).

1. Vehicle window pane (1) intended to be placed into an opening (O) in a vehicle's body (V), the opening having at least a first edge (E1) and a second edge (E2), (E1) and (E2) being continuously connected by a corner (C1), provided with an antenna system (100) comprising:
at least a first and a second antennas (A1, A2) disposed on the vicinity of the corner (C1);
the first and second antennas (A1, A2) are designed to transmit/receive radio waves in the substantially same frequency range;
the first and second antennas (A1, A2) have respectively a feeding portion (FP1, FP2) placed close to each other;
the first antenna (A1) has:
a first part (L11) extending from its feeding portion (FP1) in parallel to the first edge (E1), the corner (C1) and the edge (E2) of the opening (O), said first part (L11) being a continuous line extended from the feeding portion (FP1) along with the first edge (E1), the corner (C1) and the second edge (E2), and terminated at one crossing point (BP) along with the second edge (E2),
a second part (L12) which is extended from the crossing point (BP) on said first part (L11), the crossing point (BP) being located on a part of the first part (L11) which is substantially parallel to the second edge (E2), the second part (L12) extending from the crossing point (BP) in substantially orthogonal direction from and opposite to the second edge (E2) of the opening (O);
the second antenna (A2) has at least one part (L2) which is substantially orthogonal to the first edge (E1) of the opening (O), the part (L2) being electrically connected to the feeding portion (FP2);
wherein a distance D between the feeding portion (FP2) of the second antenna (A2) and the crossing point (BP) satisfies the following formula: D≥αλₑ/2, wherein a is shortening ratio of radio wavelength on window pane and is wavelength of radio wave at frequency fe in vacuum, fe is the highest frequency of the frequency band in which the first antenna (A1) and the second antenna (A2) works as a diversity-antenna system;
and wherein a distance D₁₁ between the second part (L12) of the first antenna (A1) and the first edge (E1) satisfies the following formula:
$$α \frac{{λ}_{s}}{8} < {D}_{11} < α {λ}_{s}$$
wherein α is shortening ratio of radio wavelength on window pane and λₛ is wavelength of radio wave at frequency fₛ in vacuum, fₛ is the lowest frequency of the frequency band in which the first antenna (A1) and the second antenna (A2) works as a diversity-antenna system.

2. Vehicle window pane according to claim 1, wherein in that a distance d between the feeding portion (FP1) of the first antenna (A1) and the feeding portion (FP2) of the second antenna (A2) satisfies the following formula: d≤50 mm.

3. Vehicle window pane according to claim 1, wherein in that a distance d₁ between the feeding portion (FP1) of the first antenna (A1) and the closest opening body's edge (E1) satisfies the following formula d₁≤αλₛ/8.

4. Vehicle window pane according to claim 1, wherein in that a distance d2 between the feeding portion (FP2) of the second antenna (A2) and the closest vehicle body's edge (E1) satisfies the following formula d₂≤αλₛ/8.

5. Vehicle window pane according to claim 1, wherein in that a distance g between the first part (L11) of the first antenna (A1) and the closest vehicle body edge (E1) satisfies the following formula g≤αλₛ/8.

6. Vehicle window pane according to claim 1, wherein in that the length (L1) of the shortest path from the feeding portion (FP1) of the first antenna (A1) to the terminating end point of the second part (L12) of the first antenna (A1) along with the antenna (A1), satisfies the following formula: (2ₙ₁−1)αλₑ/4≤L₁≤(2ₙ₁−1)αλₛ/4, with, n₁≥2, natural number and.

7. Vehicle window pane according to claim 1, wherein in that the length of the second part (L12) of the first antenna (A1) satisfies the following formula: (2n₁₂−1)αλₑ/4≤L₁₂≤(2ₙ₁₂−1)αλₛ/4, with n₁₂≥1, natural number, wherein.

8. Vehicle window pane according to claim 1, wherein in that the length of the part (L2) of the second antenna (A2) satisfies the formula: (2ₙ₂−1)αλₑ/4≤L₂≤(2ₙ₂−1)αλₛ/4, with n₂≥1, natural number.

9. Vehicle window pane according to claim 1, wherein in that the first antenna (A1) and the second antenna (A2) have further extended parts (L120, L121, L122, L21, L22).

10. Vehicle window pane according to claim 1, wherein in that the Feeding portion (FP1) of the first antenna (A1) and the second feeding portion (FP2) of the second antenna (A2) are each electrically connected to amplifier circuits (31), the amplifier circuits being provided in a same housing and having a common ground electrically connected to the vehicle body (V).
